(19) United States
(12) Patent Application Publication
(10) Pub. No.: US 2007/0255658 A1
(43) Pub. Date: Nov. 1, 2007

(54) Virtual accounts in personal finance software

(76) Inventor: George A. Grad, Boulder, CO (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/415,596

(22) Filed: May 1, 2006

(51) Int. Cl. G06Q 40/00

(52) U.S. Cl. 705/42

(57) ABSTRACT

A way to allow a user to create and manage virtual accounts in a personal software package. The user can create a virtual account and decide which of his personal accounts will fund the virtual account. He can monitor the current value of the virtual account. The user can also decide whether he has a single goal or multi-purpose goals for his virtual account.

### BACKGROUND

The present invention relates to personal finance software.

Personal and household budgets, involve both fixed monthly expenses and amounts for more long-term financial goals. It is desirable for people to manage these larger goals as a part of managing their finances.

### SUMMARY

In various embodiments the present invention provides methods and systems to allow a user to create and manage virtual accounts in a personal software package. A virtual account is a way on monitoring amounts in one or more other accounts, where some or all of the other account's value are counted as also being a value in the virtual account. The user can create a virtual account and decide how he wants to “fund” the virtual account (i.e., what accounts are monitored by the virtual account). The user can decide the source and method of funding. For example, a user may decide to fund with a percentage of a regular source of income. As the funding account increases, the virtual account generally increases until a goal is reached. Conversely, if the funding account decreases, the virtual account value generally decreases.

In one embodiment, a virtual account is funded from a single funding account. For example, a user may decide to fund his virtual account with an existing stock account, monitoring the value of the stock until the stock value increases to a desired goal. For example, a user may decide to fund with a set dollar amount from an intermittent income account, so that the virtual account increases occasionally until a goal is reached. For example, a user may decide to fund with either a percentage or a set dollar amount over a threshold amount in another account. (Thus, a user might fund his virtual account with “50% of any amount over $300 in my savings account”).

In one embodiment, if the funding account decreases in value, the virtual account also decreases. For example, if a virtual account is funded with “10% of an amount in savings over $10,000” and the savings account is valued at $15,000, then the virtual account contains $500. If, however, the savings account subsequently decreases to $11,000, then the virtual account is valued at $100. The $500 was not actually transferred from savings to the virtual account, but instead reflected a valuation of the virtual account at a particular point in time.

In one embodiment, a virtual account is funded from multiple funding accounts. For example, a user may decide to fund from two sources: a percentage from a first account and a fixed amount from a second account.

In one embodiment, a virtual account is funded for a single purpose, such as a vacation or car. This is called a single purpose virtual account. In another embodiment, the money in the virtual account is applied to a prioritized list of items that the user is saving for. This is called a multi-purpose virtual account. Whether the items in the list are to be saved for at the same time, sequentially, or some combination of at the same time and sequentially preferably is a user-determined parameter. Both single purpose virtual accounts and multi-purpose virtual accounts can be funded by either one or more than one funding account.

In one embodiment, once the goal for the virtual account is reached, the user is notified and the user closes the virtual account and manually transfers the money from the virtual account to a destination account. In one embodiment, when the user is notified of reaching the goal, specific instructions (based on the rules of the account) for how to withdraw real money would be given to the user. For example, “Withdraw $322 from savings and sell 120 shares of ABCD stock.”

One embodiment allows the user to monitor his or her progress toward the goal for the virtual account. One embodiment does not require the user to set a goal but still allows monitoring of savings progress in the virtual account.

In one embodiment, an account is a record of what a user owns or owes. Examples of accounts are: checking accounts, specific money market accounts, and savings, accounts. In one embodiment, a virtual account is a valuation at a particular point in time of money that the user owes to himself or herself. In other words, a virtual account is money earmarked for a future purpose. In one embodiment, the money is not actually moved from the funding account. But if the user views the value of his virtual account, he will see the value of the virtual account at the time he views the virtual account. In one embodiment, there is no indication in the funding account that the money has been moved or transferred to the virtual account.

### BRIEF DESCRIPTION OF THE DRAWINGS

FIG. 1(a) is a block diagram of an embodiment of the present invention in a web-based implementation.

FIG. 1(b) is a block diagram of an embodiment of the present invention in a stand-alone based implementation.

FIG. 2 is a flow chart showing an overall method of one embodiment of the present invention.

FIGS. 3 and 4 show example user interfaces that allow a user to create a virtual account.

FIG. 5(a) is a flow chart showing a method of monitoring a virtual account in accordance with one embodiment of the present invention.

FIG. 5(b) shows an example user interface that allows a user to monitor his virtual account.

FIG. 6 is a flow chart showing a method of automatically monitoring whether a virtual account has reached a goal.

FIGS. 7(a), 7(b), and 7(c) show examples of data structure in a memory of a data processing system, such as that in FIGS. 1(a) or 1(b), containing data used by an embodiment of the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

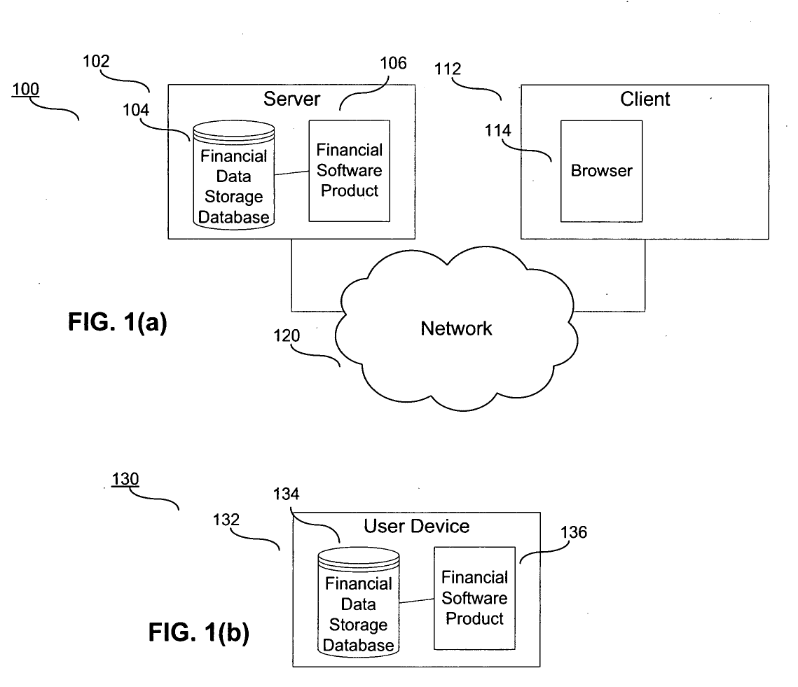

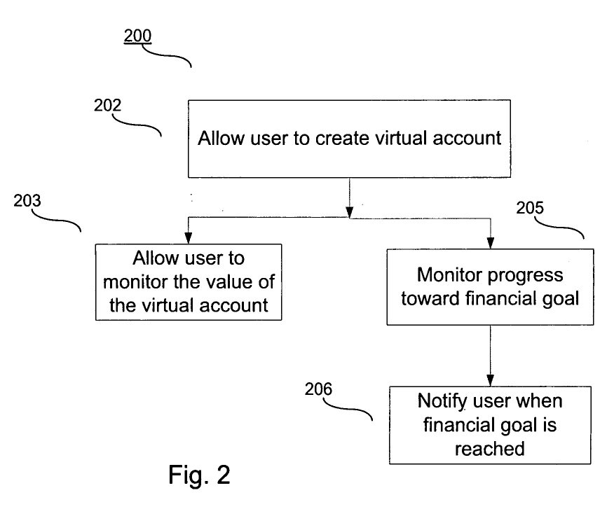

FIG. 1(a) is a block diagram illustrating the architecture of one embodiment of a system 100 showing the present invention in a web-based implementation. In this embodiment, a user uses a browser 114 to access a financial software product 106 on a server 102. In FIG. 1(a), server computer 102 communicates with client computer 112 via a network 120. Network 120 can be any appropriate network, such as the Internet, a LAN, a WAN, a MAN, a wired or wireless network, a private network, a virtual private network, or other networks. Server computer 102 contains a financial data storage database 104 in a memory (such as RAM or a hard-drive) that stores information about a user's personal finances and that is accessible by financial software product 106. Financial data storage database 104 can be, for example, either an internal or external database. Client computer 112 contains browser 114, which communicates with financial software product 106 using, for example, the http protocol, or other protocol that enables communication between applications over network 120.

FIG. 1(b) is a block diagram of an embodiment of a system 130 of the present invention in a stand-alone based implementation. In FIG. 1(b), a financial software product 136 executes on a computer 132 and accesses user financial data and other data stored on a financial data storage database 134. Financial data storage database 134 can be, for example, either an internal or external database.

Client computer 112 (FIG. 1(a)), server computer 102 (FIG. 1(a)), and computer 132 (FIG. 1(b)) are of conventional design, and include a processor, an addressable memory, and other conventional features (not illustrated) such as a display, local memory, input/output ports, and a network interface. In each embodiment, one or more components of a computer system can be located remotely and accessed via a network. In various embodiments the components of systems 100 (FIG. 1(a)) and 130 (FIG. 1(b)) may be implemented on one or more computers running a Microsoft operating system, Mac OS, various flavors of Linux, UNIX, Palm OS, and/or other operating systems.

In both FIGS. 1(a) and 1(b), any discussed software portions, modules or

functionality need not be discrete software modules. The software configuration shown is meant only by way of example; other configurations are contemplated by and within the scope of the present invention.

The financial software product 106, 136 may be provided on a computer readable media, such as a CD-ROM, diskette, or by electronic communication over the network 120 from third parties or other distributors of software, for installation and execution thereon. Alternatively, the financial software product 106, 136 and/or financial data storage database 104, 134 can be hosted on a server computer, and accessed over the network 120 by the user.

The financial data storage database 104, 134 may be a relational database or any other type of database that stores the data used by the financial software product 106, 136.

One skilled in the art will recognize that the system architecture illustrated in FIGS. 1(a) and 1(b) is merely exemplary, and that the invention may be practiced and implemented using many other architectures and environments.

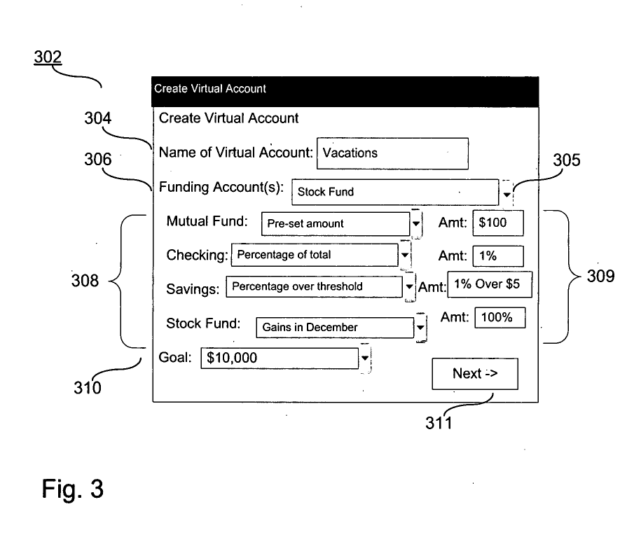

FIG. 2 is a flow chart 200 showing an overall method of one embodiment of the present invention. In this example, the method is performed by financial software, such as financial software products 106 (FIG. 1(a)), 136 (FIG. 1(b)) to implement virtual accounts.

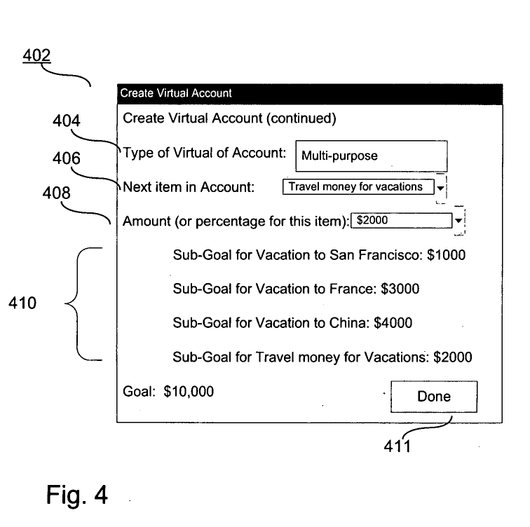

First, the financial software allows the user to create a virtual account 202. Details of this aspect of the invention are discussed below in connection with FIGS. 3 and 4. In one embodiment, an account is a record of what a user owns or owes. Examples of accounts are: checking accounts, specific money market accounts, and savings, accounts. In one embodiment, a virtual account is an amount or percentage of money that the user has earmarked for a specific purpose, even though the money is still in the funding account. In one embodiment, the money in a virtual account is not moved from the regular account until a goal is reached or the user decides to explicitly move the money between accounts. Moreover, the money is not shown as having been transferred between accounts in the funding account.

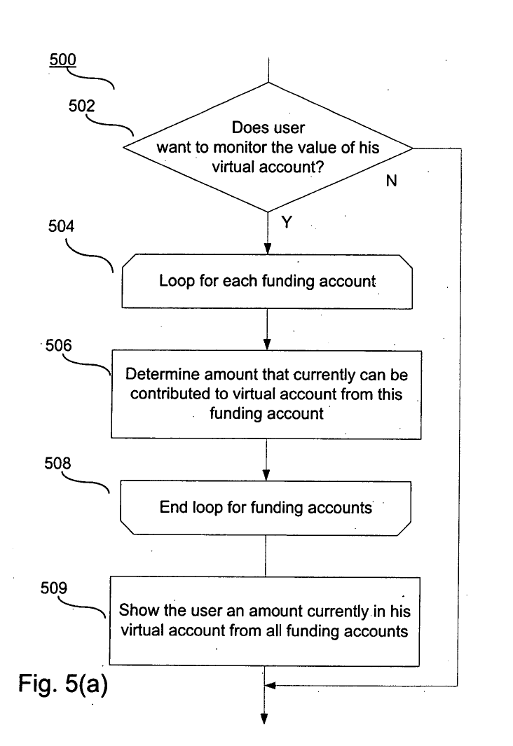

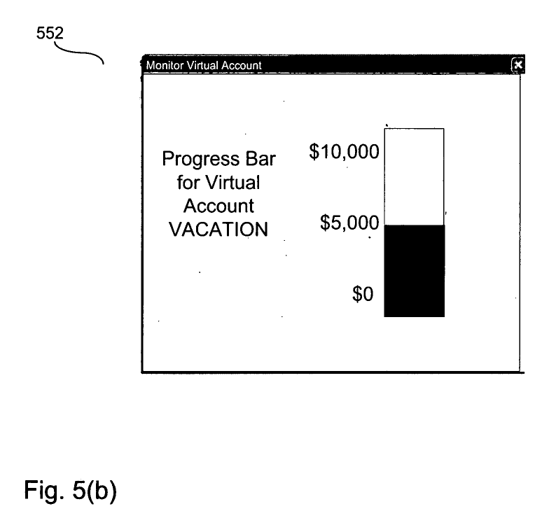

After the user creates a virtual account, the financial software allows the user to monitor the value of the virtual account 203. Details of this aspect of the invention are discussed below in connection with FIGS. 5(a) and 5(b).

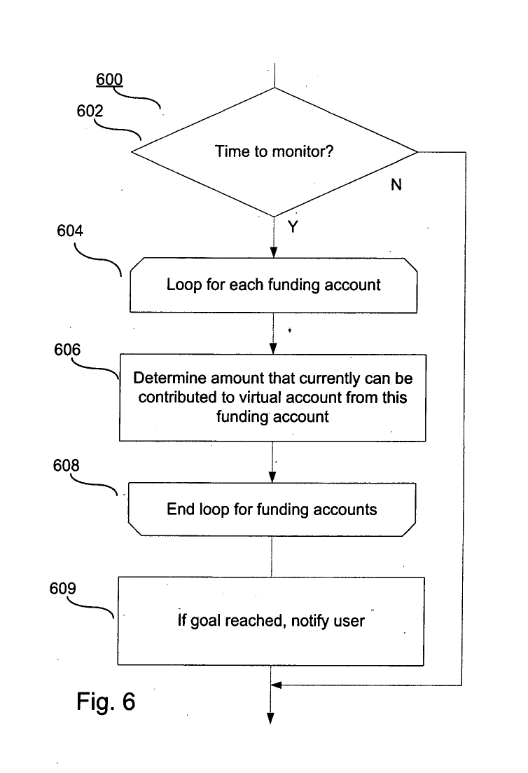

In some embodiments, after a virtual account is created, the financial software automatically monitors the value of the virtual account and progress toward a user-defined goal 205. Details of this aspect of the invention are discussed below in connection with FIG. 6(b).

The financial software notifies the user when a financial goal is reached 206. Such notification includes but is not limited to: sending an email message, notification within the financial software program when the program is started, instant messaging, a cell phone call, and an email message within an email system controlled by the financial software program.

FIGS. 3 and 4 show example user interfaces 302, 402, respectively, that allow a user to create a virtual account. The user interface 302 is one means for displaying a user interface to allow a user to create a virtual account having at least one funding account. Both user interfaces 302 and 402 (of FIG. 4) are another means for displaying a user interface to allow a user to create a virtual account having at least one funding account.

In FIG. 3, the user enters a name of the virtual account 304 (for example, “Vacations”). The user indicates the names of one or more funding accounts 306. In the example, the funding accounts are chosen from a drop down menu interface 305 listing all the user's accounts, although any appropriate method can be used. In this example, the user has indicated multiple funding accounts 308: Mutual Fund, Checking, Savings, and Stock Fund (most recently indicated and therefore still showing in funding accounts field 306).

For each indicated funding account 308, the user enters a funding rule 309. Here, the funding rules are as follows:

| Funding Account | Amount | Numerical value |
|---|---|---|
| Mutual Fund | Preset amount | $100 |
| Checking | Percentage of total | 1% |
| Saving | Percentage over | 1% over $5 |
| | threshold | |
| Stock Fund | Gains in December | 100% |

In one embodiment, the amount in the funding rule can be (but is not limited to):
pre-set amount,
percentage of total,
percentage of total, not to exceed $X
percent over threshold,
percentage over threshold, not to exceed $X,
gains in a time period (such as a specified month),
total gains,
gains, not to exceed $X,
gains, plus principle, to reach $X,
percentage of gain,
percentage of gains, not to exceed $X,
gain (or percentage of gain), but if no gain, some other amount (either percentage or fixed amount),
some amount set by a user that determines a portion of the subject account that is available to the virtual account as a part of the virtual account balance.

In one embodiment, the rules having to do with “gains” are limited to certain types of funding accounts, such as stock accounts that can gain or lose value in accordance with market conditions. In other embodiments, the rules having to do with gains can be applied to any account and “gains” are considered to be the increase in value for that account during the period in question. For example, in non-stock funds, gains might come from automatically reallocated dividends or from amounts added by the user.

FIG. 3 also shows that the user is allowed to enter a goal 310 for the virtual account (here, $10,000) according to one embodiment. Another embodiment does not require the user to set a goal but still allows monitoring of savings progress in the virtual account. For example, the user may set himself the task of saving as much as he can for a year without having a set dollar amount in mind as a final goal.

FIG. 3 shows a Next button 311 that, in one embodiment, allows the user to navigate to the user interface of FIG. 4. In contrast, another embodiment only allows the user to specify funding accounts and does not allow the user to specify the purpose of the virtual account (aside from whatever purpose is implied by its name).

FIG. 4 shows user interface 402 that continues the user interface function of FIG. 3 according to one embodiment. It allows the user to enter a type of virtual account 404. In one embodiment, the virtual account types include (but are not limited to):

Single purpose

Multi-purpose

A single purpose virtual account is an account created for one purpose, such as an account to save for a car.

In the example the user has specified a multi-purpose account, the purpose of which is to save for a list of sub-goal items each item 406 entered by the user. Here, the sub-goals items entered by the user include:
Vacation to San Francisco
Vacation to France
Vacation to China
Travel money for vacations

For each item 406 specified, the user enters a dollar amount or percentage 408 that the item counts toward the total goal. Thus, for example, “travel money for vacations” makes up $2000 of the total goal of $10,000 for the virtual account. In the example, the user has entered a sub-goal for each item in the Vacations virtual account, which has a total goal of $10,000.

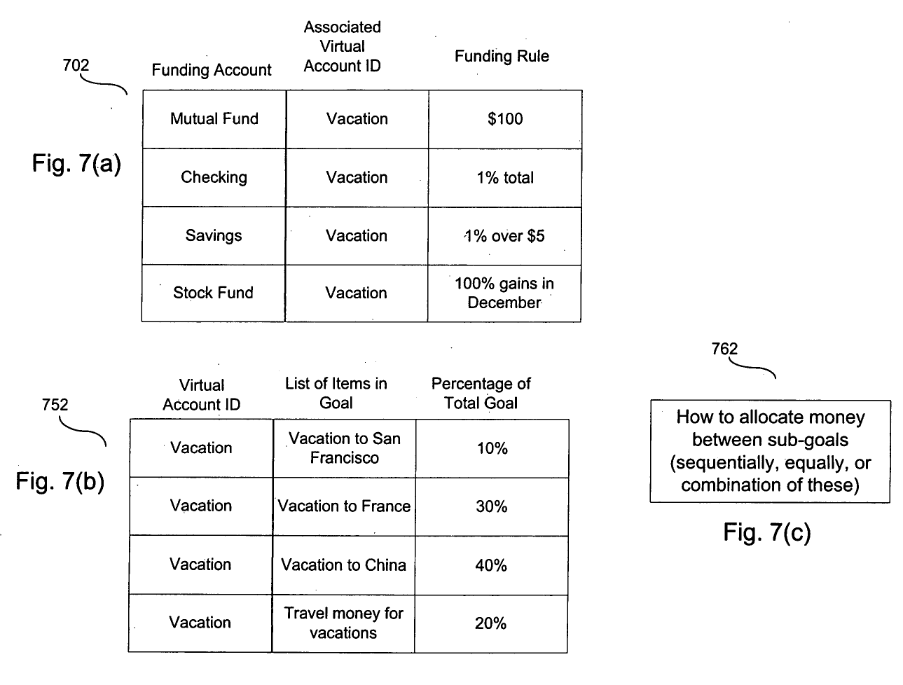

Whether the items in the list are to be saved for at the same time or sequentially is a user-entered parameter as discussed below in connection with FIG. 7(c). Although not shown in this example, one embodiment includes a user interface to allow the user to determine how to split money between goals in a multi-purpose account. Thus, here, the user may decide that he needs to save first for his San Francisco vacation since it is closest in time and may direct that all funding monies be applied to the sub-goal for the San Francisco vacation first, then that the monies be applied to a next user-selected goal and so on until all the goals are reached. Alternately, the user may select a first goal and indicate that the other goals should split funding until all sub-goals are reached. Alternately, the user may decide to split funding between all the sub-goals. In other embodiments, other variations are used for applying funding monies.

Not shown in this example, but included in some embodiments, is a user interface that allows a user to specify a category for a virtual account (or for each item in a multi-purpose virtual account). Categories include such things as: entertainment, transportation. These and other appropriate categories are used, for example, when generating reports about the user's finances.

FIG. 4 also shows a Done button 411 that, in one embodiment, allows the user to indicate that he is finished setting up the virtual account.

FIG. 5(a) is a flow chart 500 showing a method to allow the user to periodically monitor the value of his virtual account in accordance with one embodiment of the present invention. System 100 or system 130 performing the method are, respectively, means for allowing the user to monitor the value of his virtual account. In the example shown, if the user desires to monitor the value of his virtual account 502, the financial software product 106, 136 monitors each funding account that contributes to the virtual account. This is accomplished via loop 504/508. The financial software product 106, 136 determines 506 an amount that can currently be contributed to the virtual account from the current funding account(s) in accordance with the funding rules for those accounts. The user is shown an amount 509 that is currently in his virtual account based on all funding accounts for the virtual account. An example for a single purpose virtual account is shown in FIG. 5(b).

FIG. 5(b) shows an example user interface 552 that allows a user to monitor the value of his virtual account according to one embodiment. In this example, a progress bar shows progress made toward a goal of $10,000. In this example, the user's virtual account currently has a value of $5000. Other views show the progress toward a goal using other visual methods or show the progress for each sub-goal in a multi-purpose virtual account. Another view may allow the user to view a graph of progress over time for the virtual account.

Financial software product 106, 136 contains at least a creation module that performs the method of FIGS. 2-4 to create a virtual account having at least one funding account, and further contains a monitoring module that performs the method of FIG. 5(a) and 5(b) to monitor the value of the virtual account, wherein the value of the virtual account is the aggregate of amounts from the at least one funding account for the virtual account in accordance with a user-defined funding rule for each funding account, the user-defined funding rule specifying at least the an amount and a numerical value for each of the at least one funding accounts a financial data storage database, coupled to the financial software product, storing information describing the at least one funding account.

FIG. 6 is a flow chart 600 showing a method of automatically monitoring whether a virtual account has reached a goal according to one embodiment. System 100 or system 130 executing the method are, respectively, means for automatically monitoring the value of the virtual account and notifying the user when the virtual account value reaches a user-set goal. If it is time to monitor 602, financial software product 106, 136 loops through each funding account for the virtual account 604/608 to determine how much the current funding account can contribute to the goal in accordance with its funding rule 606. Based on the aggregate for all the funding accounts, if the goal is reached 609, the user is notified. For example, the user may be sent a notification message as discussed above in connection with FIG. 2. In one embodiment, when the user is notified of reaching the goal, specific instructions (based on the rules of the account) for how to withdraw real money would be given to the user. For example, “Withdraw $322 from savings and sell 120 shares of ABCD stock.”

In one embodiment, automatic monitoring occurs periodically at a system-defined interval. In one embodiment, monitoring occurs at a user-defined interval. In one embodiment, monitoring occurs at a combination of system-defined and user-defined intervals.

FIGS. 7(a), 7(b), and 7(c) show examples of data structure in a memory of the data processing system 100 of FIG. 1 (or system 130 of FIG. 1(b)) containing data used by an embodiment of the present invention. The data structures 702 and 752 are created when the virtual account is created and are populated in accordance with the user-entered values of FIGS. 3 and 4. Data structure 702 is a virtual account structure and data structure 752 is a multi-purpose virtual account structure. In one embodiment, no total amount is stored to represent money currently in the virtual account. Instead, the value of the virtual account is monitored as discussed above in connection with FIGS. 5 and 6. In one embodiment, a current value of the virtual account is periodically calculated and stored (not shown) for future use or display.

FIG. 7(c) shows a data structure 762 in memory of system 100 indicating how funding monies are to be allocated between sub-goals of a multi-purpose virtual account. This allocation scheme can be user-defined, system-defined, or a combination of both.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method of specifying a virtual savings account in financial software, comprising:
creating a virtual account having at least one funding account; and
monitoring the value of the virtual account, wherein the value of the virtual account is the aggregate of amounts from the at least one funding account for the virtual account in accordance with a user-defined funding rule for each funding account, the user-defined funding rule specifying at least the an amount and a numerical value for each of the at least one funding accounts.

2. The method of claim 1, wherein the virtual account is of a type single purpose.

3. The method of claim 1, wherein the virtual account is of a type multi-purpose.

4. The method of claim 1, wherein the at least one funding account is one of a plurality of funding accounts for the virtual account.

5. The method of claim 1, wherein the virtual account is a multi-purpose virtual account and has a plurality of sub-goals.

6. The method of claim 1, wherein the funding rule funds the virtual account with a pre-set amount from the funding account.

7. The method of claim 1, wherein the funding rule funds the virtual account with a percentage of the funding account.

8. The method of claim 1, wherein the funding rule funds the virtual account with a gain of the funding account.

9. The method of claim 1, wherein the funding rule funds the virtual account with a percentage of a gain of the funding account.

10. The method of claim 1, wherein the funding rule funds the virtual account with a pre-set amount.

11. The method of claim 1, wherein the funding rule funds the virtual account with a percentage of the funding account over a threshold value.

12. The method of claim 1, wherein the funding rule funds the virtual account with a percentage of the funding account, not to exceed a predetermined value.

13. The method of claim 1, further comprising allowing the user to specify at least one category for the virtual account.

14. The method of claim 1, further comprising automatically monitoring the value of the virtual account and notifying the user when the virtual account reaches a financial goal.

15. A computer-implemented system, comprising:
UI means for displaying a user interface to allow a user to create a virtual account having at least one funding account; and
monitor means for allowing the user to monitor the value of the virtual account, wherein the value of the virtual account is the aggregate of amounts from the at least one funding account for the virtual account in accordance with a user-defined funding rule for each funding account, the user-defined funding rule specifying at least the an amount and a numerical value for each of the at least one funding accounts.

16. A system, comprising:
a financial software product, including:
a creation module that creates a virtual account having at least one funding account, and
a monitoring module that monitors the value of the virtual account, wherein the value of the virtual account is the aggregate of amounts from the at least one funding account for the virtual account in accordance with a user-defined funding rule for each funding account, the user-defined funding rule specifying at least the an amount and a numerical value for each of the at least one funding accounts. a financial data storage database, coupled to the financial software product, storing information describing the at least one funding account; and
a financial data storage database, coupled to the financial software product, that stores data describing how the at least one funding account is used to fund the virtual account, where the creation module adds the data to the financial data storage database and the monitoring module accesses the financial storage database.

17. The system of claim 16, wherein the virtual account is of a type single purpose.

18. The system of claim 16, wherein the virtual account is of a type multi-purpose.

19. The system of claim 16, wherein the at least one funding account is one of a plurality of funding accounts for the virtual account.

20. The system of claim 16, wherein the virtual account is a multi-purpose virtual account and has a plurality of sub-goals.

21. The system of claim 16, wherein the funding rule funds the virtual account with a pre-set amount from the funding account.

22. The system of claim 16, wherein the funding rule funds the virtual account with a percentage of the funding account.

23. The system of claim 16, wherein the funding rule funds the virtual account with a gain of the funding account.

24. The system of claim 16, wherein the funding rule funds the virtual account with a percentage of a gain of the funding account.

25. The system of claim 16, wherein the funding rule funds the virtual account with a pre-set amount.

26. The system of claim 16, wherein the funding rule funds the virtual account with a percentage of the funding account over a threshold value.

27. The system of claim 16, wherein the funding rule funds the virtual account with a percentage of the funding account, not to exceed a predetermined value.

28. The system of claim 16, further comprising allowing the user to specify at least one category for the virtual account.

29. The system of claim 16, further comprising automatically monitoring the value of the virtual account and notifying the user when the virtual account reaches a financial goal.

30. A data structure, comprising:
a virtual account structure including a virtual account ID of a virtual account and identifying at least one funding source and at least one funding rule for the virtual account.

31. The data structure of claim 30, further comprising:
a multi-purpose virtual account data structure identifying multiple sub-goals for the virtual account and identifying percentages of a total goal amount allocated to each of these sub goals.

32. The data structure of claim 31, further comprising:
a data structure indicating how to allocate money between the sub-goals.
